(19) United States
(12) Patent Application Publication
(10) Pub. No.: US 2014/0340028 A1
(43) Pub. Date: Nov. 20, 2014

(54) CHARGER WITH HUB

(71) Applicants: AMBIT MICROSYSTEMS (SHANGHAI) LTD., Shanghai (CN); HON HAI PRECISION INDUSTRY CO., LTD., New Taipei (TW)

(72) Inventors: JIAN-FENG XIAO, Shanghai (CN); BIN HUANG, Shenzhen (CN)

(73) Assignees: HON HAI PRECISION INDUSTRY CO., LTD., New Taipei (TW); AMBIT MICROSYSTEMS (SHANGHAI) LTD., Shanghai (CN)

(21) Appl. No.: 14/251,211

(22) Filed: Apr. 11, 2014

(30) Foreign Application Priority Data
May 14, 2013 (CN) 2013202599032

(51) Int. Cl. H02J 7/00

(52) U.S. Cl. CPC H02J 7/0044
USPC 320/108

(57) ABSTRACT

A charger includes an enclosure, a charging circuit received in the enclosure., a latching member and a pair of elastic members. The enclosure defines a matching groove. The pair of elastic members are electrically connected to the charging circuit and are mounted on opposite sidewalls of the matching groove. The latching member is mounted in the matching groove, and is flexible. The present disclosure further provides a hub matching with the charger. The hub includes a main body, a circuit unit, a bulge and a pair of conductive pieces. The main body defines a receiving groove. The bulge protrudes from a bottom of the receiving groove. The pair of conductive pieces are electrically connected to the circuit unit and are located at opposite sidewalls of the bulge. A sidewall of the bulge defines a latching hole, and the latching member latches with an edge of the hole.

### BACKGROUND

1. Technical Field

The present disclosure generally relates to a charger and a hub matched with the charger, more particularly to a charger and a hub matched with the charger for a cordless telephone.

2. Description of Related Art

Cordless telephones are widely used. A cordless telephone includes a host, an auxiliary machine and a hub for a connection between the host and the auxiliary machine. A rechargeable battery is usually set in the auxiliary machine. Thus, two chargers should be prepared, one for the hub and the other one for auxiliary machine, which leads to high cost.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic, isometric view of a charger and a hub matched with the charger of one embodiment of the disclosure.

FIG. 2 is a schematic isometric perspective view of the charger of FIG. 1.

FIG. 3 is a cutaway view of the hub of FIG. 1.

FIG. 4 is another schematic view of the hub of FIG. 1.

FIG. 5 is a cross sectional view of the charger and the hub matched with the charger taken along line V-V of FIG. 1.

FIG. 6 is a cross sectional view taken along line VI-VI of the charger and the hub matched with the charger taken along line VI-VI of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

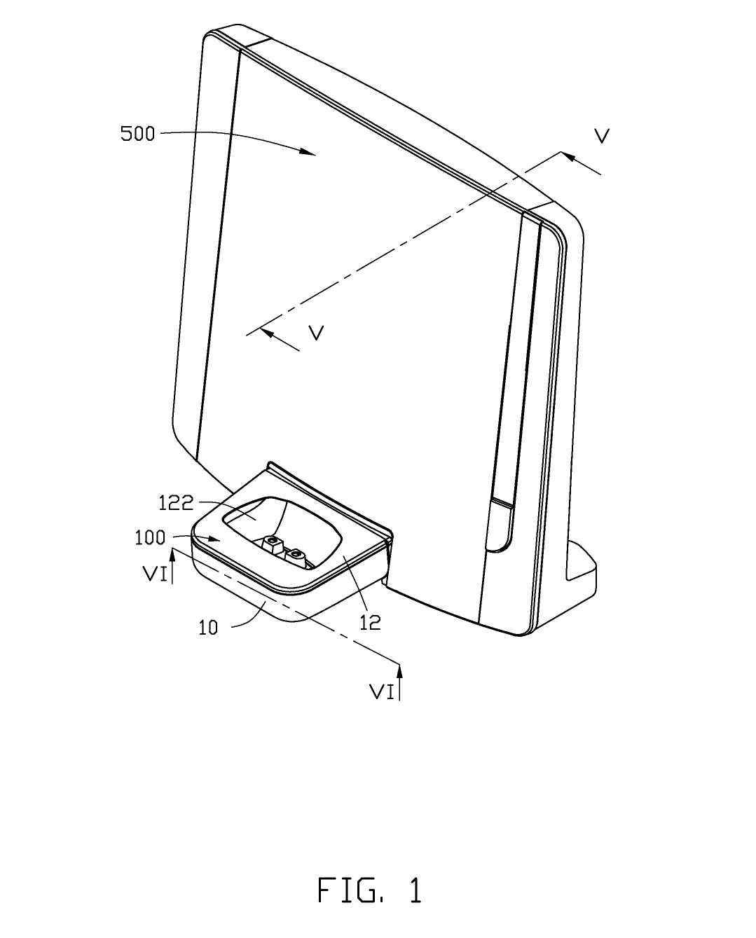

FIG. 1 shows that a charger 100 is electrically connected to a hub 500. The charger 100 charges an electronic device (not shown) when the hub 500 is powered. The hub 500 is used for receiving and sending wireless signals to the electronic device. In other embodiments, the electronic device may be a cordless telephone or a mobile phone, but the disclosure is not limited thereto.

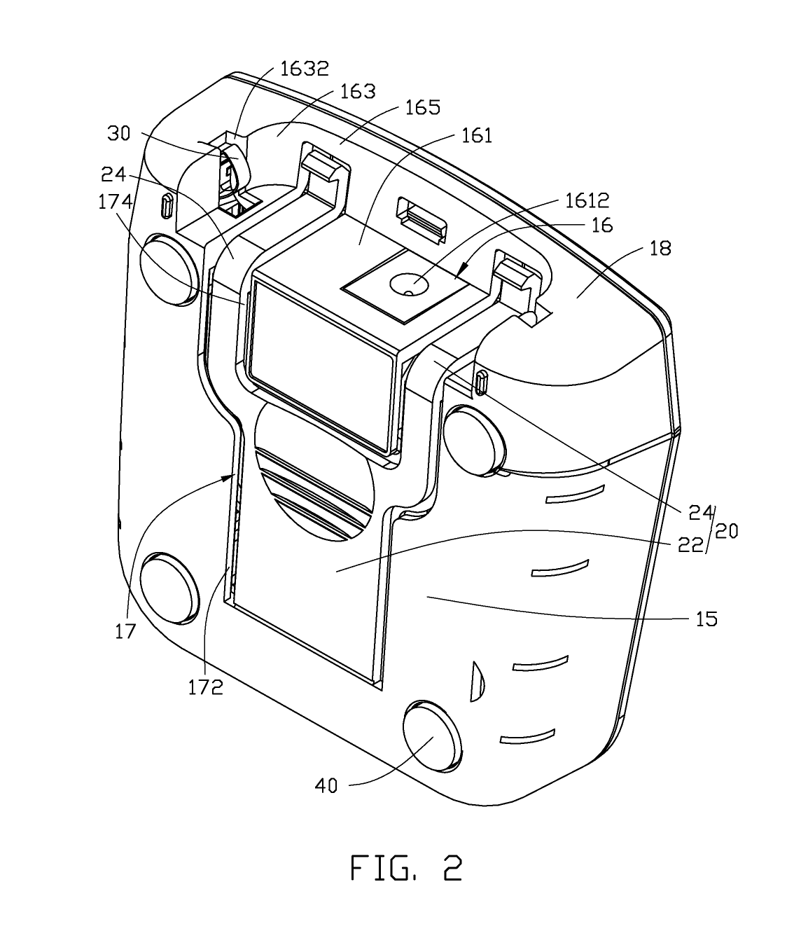

Referring also to FIG. 2, the charger includes an enclosure 10, a charging circuit (not shown) received in the enclosure 10, a latching member 20 located on the enclosure 10, a pair of elastic members 30 and a plurality of supporting seats 40.

The enclosure 10 includes a first surface 12, a second surface 15 opposite to the first surface 12 and a sidewall 18 connected with the first surface 12 and the second surface 15. The first surface 12 defines a fitting groove 122 for receiving and charging the electronic device. A matching groove 16 is located at a connection of the second surface 15 and the sidewall 18. The matching groove 16 includes a floor 161, a pair of opposite first sidewalls 163 and a second sidewall 165 connected with the first sidewalls 163. A jack 1612 is located on a central section of the floor 161. The second surface 15 defines a groove 17 extending to the matching groove 16. The groove 17 includes a main portion 172 and two extensions 174 extending from an end of the main portion 172. The two extensions 174 are bent and respectively extend through the floor 161 until reach the second sidewall 165. The pair of first sidewall 163 each defines a slot 1632. The slots 1632 pass through the sidewall 18 and the floor 161.

The latching member 20 is received in the groove 17. The latching member 20 is elastic and includes a plate 22 firmly fixed in the main portion 172 and a pair of hooks 24. The pair of hooks 24 extend through the two extensions 174 and are convexly arranged with the second sidewall 165.

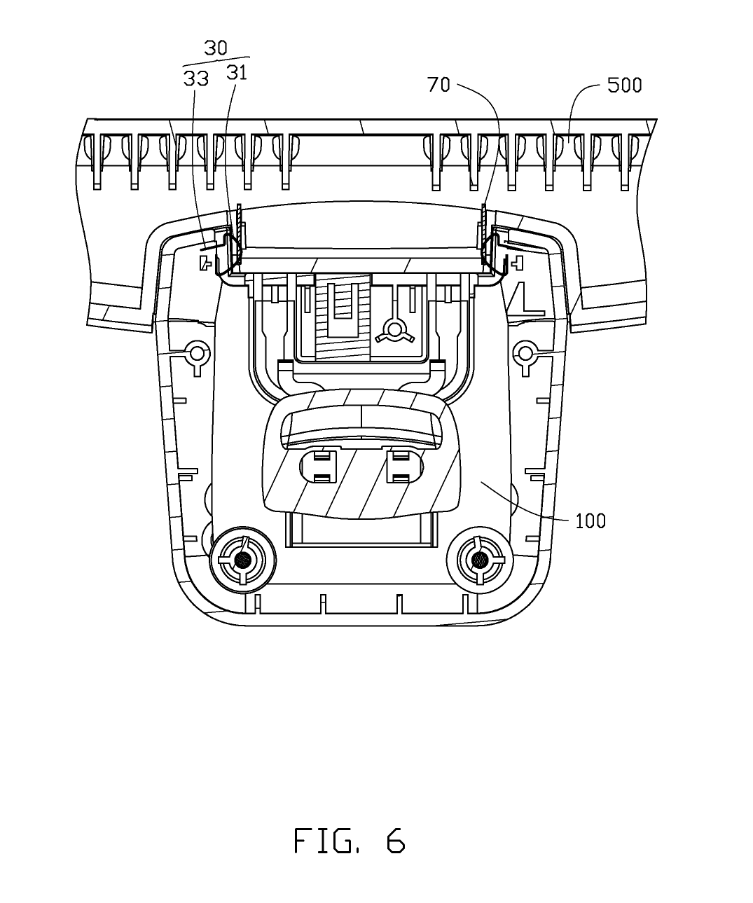

The pair of elastic members 30 which conduct electricity are respectively secured in the slots 1632. The pair of elastic members 30 electrically connected to the charging circuits includes an electrode contact 31 and a connector 33 (see FIG. 6). The electrode contact 31 is arched and extends into the matching groove 16. The connector 33 firmly fixed in the slot 1632 is roughly in a shape of strip and is electrically connected with the charging circuits.

Four supporting seats 40 are located at four corners of the second surface 15 for supporting the charger 100. Alternatively, quantities of the supporting seat 40 may be changed according to different requirements.

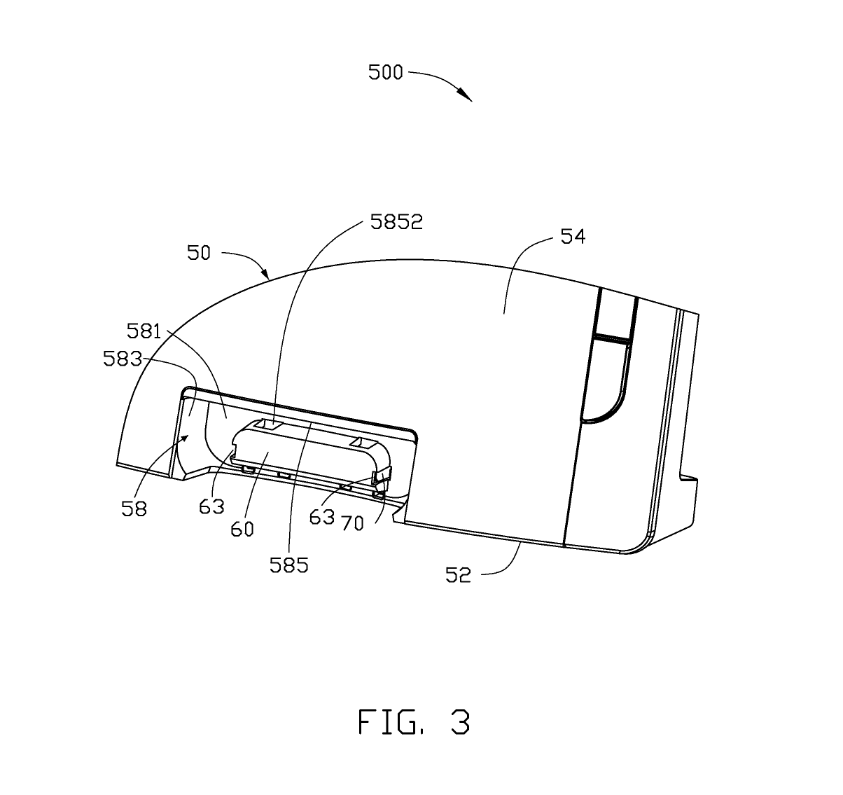

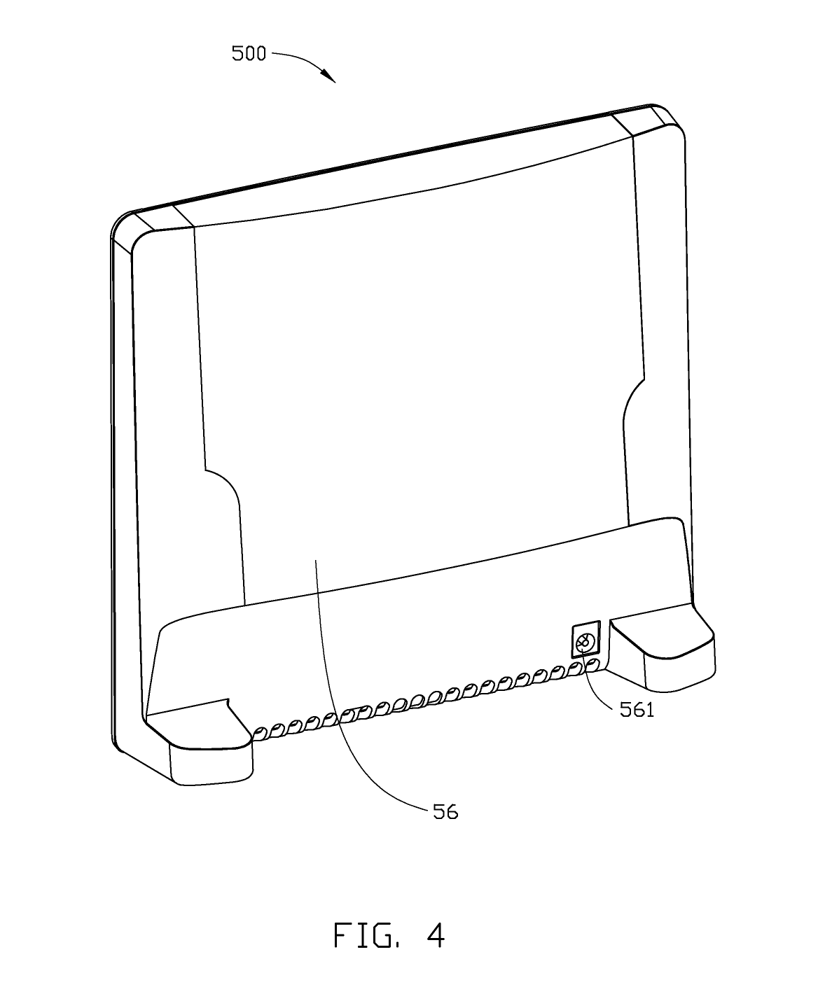

FIG. 3 and FIG. 4 show that the hub 500 includes a foundation 50, a circuit unit (not shown) received in the foundation 50, an antenna (not shown) connected with the circuit unit for receiving signals, a bulge 60 mounted in the foundation 50 and a pair of conductive pieces 70. The foundation 50 includes a base side 52, a first side 54 and a second side 56 opposite to the first side 54. The base side 52 is connected with the first side 54 and the second side 56. A holder 58 is concavely located at a connection of the base side 52 and the first side 54. The holder 58 includes a bottom 581 substantially parallel to the first side 54, a pair of opposite first lateral walls 583 perpendicularly with the bottom 581 and a second lateral wall 585 connected with the pair of first lateral walls 583. The second side 56 defines a second jack 561 for connecting to the power supply for the hub 500.

The bulge 60 extends from the bottom 581 of the holder 58 and toward the first side 54. The bulge 60 defines a pair of concave holes 5852 located on a side of the bulge 60 adjacent to the second lateral wall 585. The hooks 24 are engaged with the concave holes 5852. A pair of fixing grooves 63, perpendicularly with the bottom 581 are respectively located at another two opposite sides of the bulge 60. The pair of conductive pieces 70 contacting the elastic members 20 are respectively mounted in the pair of fixing grooves 63. An end of the conductive piece 70 is electrically connected with the circuit unit of the hub 500.

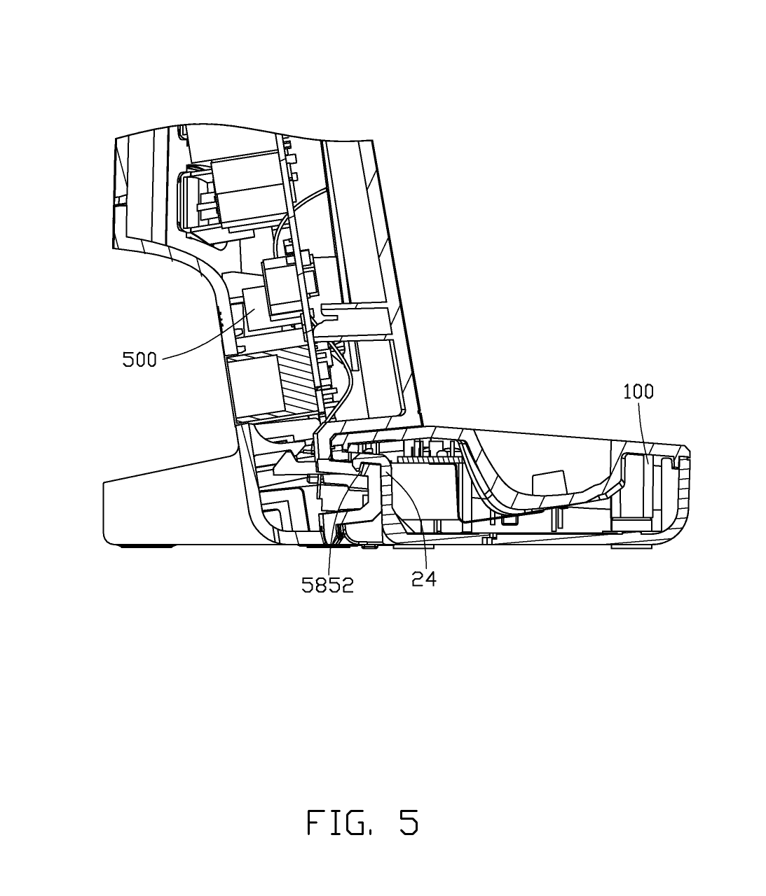

In use, the charger 100 is received in the hub 500 and the electronic device is set in the fitting groove 122. The electronic device electrically connects to the charging circuit of the charger 100. The bulge 60 is received in the matching groove 16. The hook 24 latches with the concave hole 5852 (see FIG. 5). The elastic members 30 electrically contact the conductive piece 70.

In the embodiment, the latching member 20 includes two hooks 24, and the groove 17 correspondingly includes two extensions 174. Alternatively, the quantities of the hooks 24 and extension 174 may be changed according to different requirements.

The charger 100 and the hub 500 matched with the charger 100 of the disclosure can charge an electronic device when power the hub 500, which leads to saving power and money.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A charger, comprising:
an enclosure comprising a first surface, a second surface opposite to the first surface, and a sidewall connected with the first surface and the second surface, the first surface defining a fitting groove for fitting an electronic device, wherein a matching groove is defined at a connection of the second surface and the sidewall, and the matching groove comprises a floor, a pair of opposite first sidewalls, and a second sidewall connected with the first sidewalls; and
a charging circuit received in the enclosure;
a pair of elastic members located on the pair of opposite first sidewalls and electrically connected to the charging circuit; and
a flexible latching member comprising a hook partly received in the matching groove.

2. The charger of claim 1, wherein the second surface of the enclosure comprises a groove extending to the matching groove, the groove comprises a main portion and an extension extending from an end of the main portion, the extension is bent and extends through the floor of the matching groove to the second sidewall.

3. The charger of claim 2, wherein the latching member further comprises a plate fixed in the main portion of the groove, the hook extending from an end of the plate is received in the extension of the groove and is convexly arranged with the matching groove.

4. The charger of claim 3, wherein a quantity of the extension of the groove is two, the two extensions extend from two sides of a end of the main portion toward the matching groove, a quantity of the hook of the elastic member is two, the two hooks are correspondingly received in the two extensions and convexly arranged in the matching groove.

5. The charger of claim 1, wherein the pair of first sidewalls each comprise a slot passing through the sidewall and the floor, and the pair of elastic members are respectively secured in the slots.

6. The charger of claim 5, wherein the pair of elastic members each comprise an electrode contact and a connector extending from an end of the electrode contact, the electrode contact is arched and extends into the matching groove, and the connector fixed in the slot is electrically connected with the charging circuit.

7. A hub matched with a charger, comprising:
a foundation comprising a first side, a second side opposite to the first side and a base side connected with the first side and the second side;
a circuit unit received in the foundation;
an antenna connected with the circuit unit for receiving signals;
a holder for receiving the charger, the holder being concavely located at a connection of the base side and the second side, the holder comprising a bottom parallel to the first side, a pair of opposite first lateral walls, a second lateral wall connected with the pair of opposite first lateral walls;
a bulge mounted in the holder; and
a pair of conductive pieces electrically connected to the circuit unit secured at two opposite sides of the bulge forward the first lateral walls, a side of the bulge adjacent to the second lateral wall defining a concave hole engaged with a hook of the charger.

8. The hub of claim 7, wherein the bulge received in the holder extends from the bottom of the holder and toward the first side.

9. The hub of claim 7, wherein a pair of fixing grooves are respectively located at two opposite sides of the bulge forward the first lateral walls, the pair of fixing grooves being perpendicular to the bottom, and the pair of conductive pieces are correspondingly mounted in the pair of fixing grooves.

10. The hub of claim 7, where a quantity of the concave hole is two.

11. The hub of claim 7, wherein the second side of the foundation comprise a jack connecting to a power.
